(19) United States
(12) Patent Application Publication
(10) Pub. No.: US 2002/0143992 A1
(43) Pub. Date: Oct. 3, 2002

(54) Method of determining a physical locale from an IP address

(76) Inventors: Robert E. McElhaney, Berwick, ME (US); John Esposito, Marlborough, MA (US); Davis Foulger, Wappingers Fall, NY (US); William Babcock, Lakeville, MA (US); William Minckler, Waltham, MA (US)

Correspondence Address: DALY, CROWLEY & MOFFORD, LLP, SUITE 101, 275 TURNPIKE STREET, CANTON, MA, 02021-2310, US

(21) Appl. No.: 09/911,171

(22) Filed: Jul. 23, 2001

Related U.S. Application Data
(60) Provisional application No. 60/220,918, filed on Jul. 26, 2000.

(51) Int. Cl. G06F 15/16

(52) U.S. Cl. 709/245

(57) ABSTRACT

A method of determining a physical locale from a node name is presented. The method includes the steps of obtaining a DNS name from a node on a network, parsing the name, and obtaining the name of the Network Service Provider (NSP) from the parsed name. Each NSP has a particular rule set associated therewith, and the appropriate rule set is executed. The rule set extracts the city name, which indicates the general area where the node is located.

### CROSS REFERENCE TO RELATED APPLICATIONS

This application claims priority under 35 U.S.C. § 119(e) to provisional patent application serial No. 60/220,918 filed Jul. 26, 2000; the disclosure of which is incorporated herein by reference.

### FIELD OF THE INVENTION

The present invention relates generally to analyzing IP addresses and more specifically to analyzing an IP address and determining a physical locale of the node associated with the IP address.

### BACKGROUND OF THE INVENTION

Domain Naming Service (DNS) is an Internet Protocol and distributed database which provides a mapping feature between hostnames and IP addresses. A host name, for example Empirix.com, includes a top-level domain to which the host belongs (the .com part). The IP address comprises a thirty-two bit integer written as four numbers separated by periods (e.g. 209.224.2.20). Each number is between zero and 255.

When a node name is typed in, for example as a destination web site to visit in a web browser, the browser sends a request to the closest name server. The name server will attempt to map the name of the destination web site to an IP address. If the closest name server cannot map the node name to an IP address, the name is passed to a second server which will attempt to map the name to an IP address. This process continues until either the name is mapped to an IP address, or a message will be returned that the domain name doesn't exist. When the name is mapped to an IP address, the address is passed back to the browser, and connection to the destination web site is initiated.

As a web site owner, the site may be getting plenty of hits, but it is difficult to determine where the hits are coming from. For example, the owner of a commercial web site may be getting plenty of hits from a certain part of the country, but few or none from a different part of the country. The web site owner would like to be made aware of this so that he or she could target marketing efforts to the parts of the country where the web site is not getting much action. Accordingly, it would be desirable to provide a method for determining the physical locale of an entity from the IP address associated with that entity.

### SUMMARY OF THE INVENTION

A method of determining a physical locale from a node name is presented. The method includes the steps of obtaining a DNS name from a node on a network, parsing the name, and obtaining the name of the Network Service Provider (NSP) from the parsed name. Each NSP has a particular rule set associated therewith, and the appropriate rule set is executed. The rule set extracts the city name, which indicates the general area where the node is located.

### BRIEF DESCRIPTION OF THE DRAWINGS

The invention will be more fully understood from the following detailed description taken in conjunction with the accompanying drawings, in which:

FIG. 1 is a flow chart of the presently disclosed method.

### DETAILED DESCRIPTION OF THE INVENTION

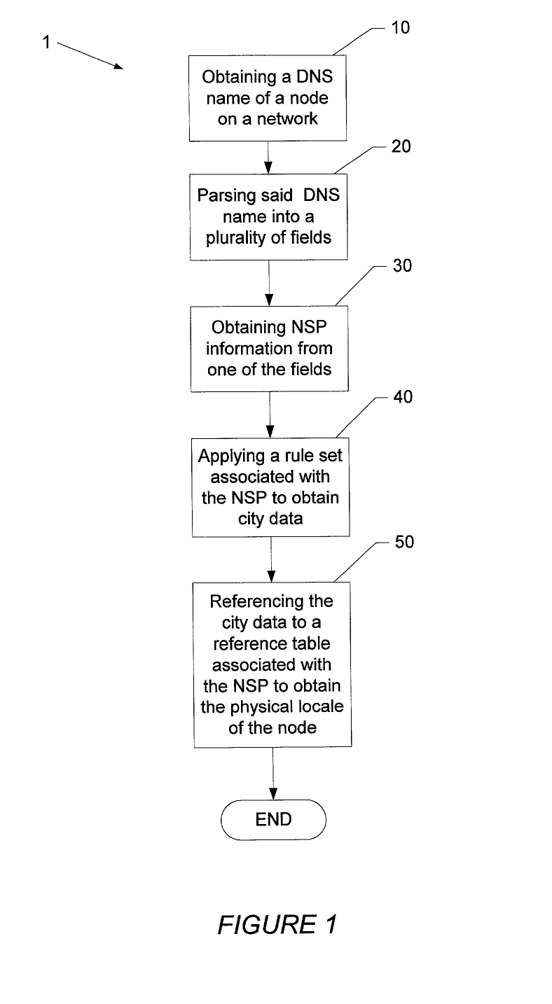

A method of determining a physical locale of a node from the node's DNS is presented. While the presently disclosed method could be preformed manually, it is preferably performed by a computer running software which performs the method. Referring now to FIG. 1, a flow chart of the presently disclosed method 1 is shown. The first step 10 comprises obtaining a DNS name of a node on a network. This DNS name can be obtained by any means known to those of reasonable skill in the art. Typically the DNS name is obtained from a web site access. The owner of a web site wishes to determine the locales across the world which are accessing the owner's web site. There may be several reasons for this—such as determining the effectiveness of marketing campaigns, determining areas of interest in the web site around the world, or simple curiosity regarding who is accessing the web site.

At the next step, step 20, the DNS name is parsed into a plurality of fields. Typically, the delimiter used to parse the name into the fields is a period. This will result in anywhere from four to seven fields depending on the Network Service Provider (NSP) used with the DNS name. Table 1 shows the major NSPs.

TABLE 1
MAJOR NSPs
Alter.net
Att.net
Bbnplanet.net
Cw.net
Digex.net
Gblx.net
Level3.net
Qwest.net
Sprintlink.net
Verio.net
Wcg.net

At step 30 the NSP identification is obtained from examining the two right-most fields of the parsed DNS name. The NSP identification is also used to identify the appropriate rule set to be used in identifying the locale associated with the DNS name.

At step 40, the appropriate rule set (described in detail below) is used to obtain the city code. From the city code, a corresponding city can be identified, as recited in step 50. The identified city is the approximate physical locale of the DNS name. While the exact locale cannot be determined, the approximate physical locale is determined, which is the closest major city to the node.

The rule sets are different depending on the NSP. The rule set for alter.net relates that after parsing the DNS name, there will be either 5 or 6 fields. The third field from the right contains the city data followed by a number. The number is discarded, and the remainder of the third field from the right is compared with the entries of table 2 to identify the city.

TABLE 2

| City Code | City |
|---|---|
| Atl | Atlanta |
| Bos | Boston |
| Chi | Chicago |
| Cph | Copenhagen |
| Dfw | Dallas/Ft. Worth |
| Hkg | Hong Kong |
| Hou | Houston |
| Jax | Jacksonville |
| Kcy | Kansas City |
| Ind | London, England |
| Lax | Los Angeles |
| Nyc | New York City |
| Pao | Palo Alto |
| Por | Portland, OR |
| Sac | Sacramento |
| Ssfo | San Francisco |
| Scl | Santa Clara |
| Stl | St. Louis |
| Dca | Washington, DC |

An example of the alter.net NSP addressing is:

297.ATM6-0.XR1 .ATL1 .ALTER.NET (152.63.81.21)

After parsing, the third field from the right contains ATL1. The number 1 is discarded, and the remainder (ATL) is cross-referenced in table 2 to show that the city of the DNS name is Atlanta.

When ATT.NET is the NSP the corresponding rule set dictates that after parsing the the name wil contain five fields. The fourth field from the right contains the city data. The city data is cross-referenced in table 3 to reveal the city.

TABLE 3

| City Code | City |
|---|---|
| Cgcil | Chicago |
| Dlstx | Dallas |
| Dvmco | Denver |
| Kszmo | Kansas City |
| La2ca | Los Angeles |
| Sffca | San Francisco |
| Dca | Washington, DC |

An example of the ATT,NET NSP addressing is:

Gbr1-p11.sffca.ip.att.net (12.123.12.238)

After parsing, the fourth field from the right contains the city data sffca which cross-references in table 3 to San Francisco.

A more complex rule set is required when BBNPLANET.NET is the NSP. The corresponding rule set dictates that after parsing the name will contain four fields. The third field from the right contains the city data and router data. This field must be parsed a second time using a dash as the delimiter. The field which was parsed will now comprise two sub fields, in which the left-most sub-field contains the city data with a number concatenated onto it. The concatenated number is discarded. The remaining city data is cross-referenced in table 4 to reveal the city.

TABLE 4

| City Code | City |
|---|---|
| Boston | Boston |
| Bstnma | Boston |
| Cambridge | Cambridge, MA |
| Crtntx | Carrollton, TX |
| Chcgil | Chicago |
| Dallas | Dallas |
| Hnllhi | Honolulu |
| Lsanca | Los Angeles |
| Nashua | Nashua, NH |
| Nycmny | New York City |
| Sanjose | San Jose |
| Vienna | Vienna, VA |
| washdc | Washington, DC |

An example of the BBNPLANET.NET NSP addressing is:

A5-0-1 .sanjose1-nbr1.bbnplanet.net (4.24.145.1)

After parsing, the third field from the right contains the city data sanjose1 and the router data nbr1. This is parsed again to get the city data sanjose1 which has a number concatenated onto it. The number is discarded, leaving the city data sanjose which cross-references in table 4 to San Jose.

The rule set for the NSP CW.NET dictates that after parsing the name will contain four fields. The third field from the right contains the city data. The city data is cross-referenced in table 5 to reveal the city.

TABLE 5

| City Code | City |
|---|---|
| Dallas | Dallas |
| Sacramento | Sacramento |
| Sanfrancisco | San Francisco |
| Seattle | Seattle |
| Washington | Washington, DC |
| Westorange | West Orange, NJ |
| willowsprings | Willow Springs, MO |

An example of the CW.NET NSP addressing is:

Corerouter2.willowsprings.cw.net (204.70.9.146)

After parsing, the third field from the right contains the city data willowsprings. This cross-references in table 5 to Willow Springs, Mo.

The rule set for the NSP DIGEX.NET dictates that after parsing the name will contain four fields. The left-most field contains the city data along with other information, separated by dashes. This field is then parsed again, this time using a dash as the delimiter. This will result in three to five subfields. The left most subfield contains the city data with a number concatenated onto the end of it. The number is discarded and the city data is left. The city data is cross-referenced in table 6 to reveal the city.

TABLE 6

| City Code | City |
|---|---|
| Alb | Albany |
| Bos | Boston |
| ord | Chicago |
| Cvg | Cincinatti |
| Cle | Cleveland |
| Dfw | Dalls/Ft. Worth |
| Dtw | Detroit |
| Fll | Ft. Lauderdale |
| Iad | Herndon, VA |
| Ind | Indianapolis |
| Jax | Jacksonville |
| Lax | Los Angeles |
| Mia | Miami |
| Jfk | New York City |
| Oma | Omaha |
| Phl | Philadelphia |
| Pit | Pittsburgh |
| Pvd | Providence |
| Smf | Sacramento |
| Slc | Salt Lake City |
| Sfo | San Francisco |
| Sjc | San Jose |
| Dca | Washington, DC |

An example of the DIGEX.NET NSP addressing is:

Phl2-core2-fa0-1-0.atlas.digex.net (165.117.51.37)

After parsing, the left-most field contains phl2-core-fa0-1-0. This is parsed again using a dash as the delimiter to yield the city code and a number in the left-most subfield. The number is discarded, leaving phl. This cross-references in table 6 to Philadelphia.

The rule set for the NSP GBLX.NET dictates that after parsing the name will contain four or five fields. The third field from the right contains the city data which may also have a number added to it. If there is a number, the number is discarded. The city data is cross-referenced in table 7 to reveal the city.

TABLE 7

| City Code | City |
|---|---|
| Chi | Chicago |
| Cle | Cleveland |
| Den | Denver |
| Iad | Herndon, VA |
| PhxHou | Phoenix |
| Sfo | San Francisco |
| Snv | Sunnyvale, CA |
| Wdc | Washington, DC |

An example of the GBIX.NET NSP addressing is:

Pos10-1-0-crl.PHX.gblx.net (206.132.117.82)

After parsing, the third field from the right contains the city data PHX. This cross-references in table 7 to Phoenix.

The rule set for the NSP LEVEL3.NET dictates that after parsing the name will contain four fields. The third field from the right contains the city data which may have a number concatenated onto it. The number is discarded. The city data is cross-referenced in table 8 to reveal the city.

TABLE 8

| City Code | City |
|---|---|
| Bos | Boston |
| Chicago | Chicago |
| Newyork | New York City |
| Philadelphia | Philadelphia |
| Sanjose | San Jose |
| Washington | Washington, DC |

An example of the LEVEL3.NET NSP addressing is:

Hsipaccess1.NewYork1.level3.net (209.244.2.20)

After parsing, the third field from the right contains the city data and a number NewYork1. The number is discarded leaving NewYork. This cross-references in table 8 to New York City.

The rule set for the NSP QWEST.NET dictates that after parsing the name will contain four fields. The left-most field contains the city data along with other information. This field must be parsed using a dash as the delimiter. The left-most subfield contains the city data. The city data is cross-referenced in table 9 to reveal the city.

TABLE 9

| City Code | City |
|---|---|
| Chi | Chicago |
| Dal | Dallas |
| Den | Denver |
| Kcm | Kansas City |
| Lax | Los Angeles |
| Nyc | New York City |
| Sfo | San Francisco |
| Sjo | San Jose |
| Svl | Sunnyvale, CA |
| Wdc | Washington, DC |

An example of the QWEST.NET NSP addressing is:

Wdc-edge-05.inet.qwest.net (205.171.4.193)

After parsing, the left-most field contains the city data and other data. This information is parsed again, using a dash as the delimiter. The left-most subfield contains the city data wdc. The city data is cross-referenced in table 9 to Washington, D.C.

The rule set for the NSP SPRINTLINK.NET dictates that after parsing the name will contain three fields. The left-most field contains the city data along with other information. This field is parsed using a dash as the delimiter. This parsing will result in between four and eight subfields. The third subfield from the left will contain the city data. The city data is cross-referenced in table 10 to reveal the city.

TABLE 10

| City Code | City |
|---|---|
| Ana | Anaheim connects to kddnet.ad.jp (Japan) |
| Che | Cheyenne, WY |
| Chi | Chicago |
| fw | Ft. Worth |
| Kc | Kansas City |
| Pen | Pennsauken, NJ |
| Roa | Roanoke, VA |
| Stk | Salt Lake City |
| Sj | San Jose |
| Sea | Seattle |
| Tac | Tacoma |
| Dc | Washington, DC |
| Wa | Washington, DC connects to xara.net (UK) |

An example of the SPRINTLINK.NET NSP addressing is:

S1-gw5-kc-1-1-1-28m.sprintlink.net (144.232.132.13)

After parsing, the first field from the left contains the city data surrounded by other data. This field is parsed using a dash delimiter to yield between four and eight subfields. The third subfield from the left contains the city code, in this instance kc. This is cross-referenced in table 10 to give the city as Kansas City.

There are two rule sets for the NSP VERIO.net. After parsing the name, there will be either four or seven fields. A first rule set applies if there are four fields. In the first rule set the left-most field contains the city data and a number. The number is discarded leaving the city data The city data is cross-referenced in table 11 to reveal the city.

A second rule set applies if there are seven fields after the initial parsing step. The fifth field from the right will contain the city data and may also contain a number, which if present is discarded. The city data is cross-referenced in table 11 to reveal the city.

TABLE 11

| City Code | City |
|---|---|
| Dllstx | Dallas |
| Dfw | Dallas/Ft. Worth |
| Mdt | Harrisburg, PA |
| Iad | Herndon, VA |
| Kscymo | Kansas City |
| Nyc | New York City |
| Nycmny | New York City |
| Omahne | Omaha |
| Pao | Palo Alto |
| Pen | Pennsauken, NJ |
| Phi | Philadelphia |
| Phlapa | Philadelphia |
| Tpkaks | Topeka |
| Tpk | Topeka |
| Dca | Washington, DC |

An example of the VERIO.NET NSP addressing for the first rule set is:

Iad3.dfw2.verio.net (129.250.2.209)

After parsing, the left-most field contains the city data and a number. The number is discarded leaving the city data. This cross-references in table 11 to Herndon, Va.

An example of the VERIO.NET NSP addressing for the second rule set is:

fa-1-1-0.a02.kscymo01.us.ra.verio.net (129.250.16.98)

After parsing, the fifth field from the right contains the city data and occasionally a number. When a number is present the number is discarded leaving the city data. This cross-references in table 11 to Kansas City.

The rule set for the NSP WCG.NET dictates that after parsing the name will contain four fields. The left-most field contains the city data along with other information. The left-most filed is parsed using the numbers zero through nine as delimiters. The left most subfield contains the city data. The city data is cross-referenced in table 12 to reveal the city.

TABLE 12

| City Code | City |
|---|---|
| Atlnga | Atlanta |
| Chicgil | Chicago |
| Dfw | Dallas |
| Lax | Los Angeles |

An example of the WCG.NET NSP addressing is:

Atlnga1wce1-oc12-atm4-ipcc.wcg.net (151.1429.221.134)

After parsing, the left-most field will contain the city data and other information. A second parsing operation is done using the digits zero through 9 as the delimiter. The left most subfield contains atlnga which cross-references in table 12 to Atlanta.

In the event that a city is not able to be determined , the router nearest the source is used, and the method repeated again to obtain the city data that corresponds to the router. This is then used as the physical locale of the node associated with the IP address.

As described above the present invention permits the determination of a physical locale of a node from the domain name associated with the node. The DNS name is parsed, and a rule set associated with the particular network service provider is utilized to determine the physical locale of the node. While only a set of NSPs were described, it should be understood that there are many more NSPs, and that the invention is applicable to these NSPs as well. Additionally, it may be desirable only to determine the physical locale of a country, since some NSPs are only in a single country.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims. All publications and references cited herein are expressly incorporated herein by reference in their entirety.

What is claimed is:

1. A method of determining a physical locale of a node comprising the steps of:
obtaining a Data Naming Service (DNS) name of a node on a network;
parsing said DNS name into a plurality of fields;
comparing at least one of said plurality of fields to a Network Service Provider (NSP) list to determine the NSP of said node;
applying a rule set associated with said NSP to another of said plurality of fields to obtain city data; and
referencing said city data in a reference table associated with said NSP to obtain the physical locale of said node.

2. The method of claim 1 wherein said NSP is selected from the group consisting of alter.net, att.net, bbnplanet.net, cw.net, digex.net, gbix.net, level3.net, qwest.net, sprintlink.net, verio.net, and wcg.net.

3. The method of claim 1 wherein said step of parsing said DNS name is performed using a period as a delimiter.

4. The method of claim 1 wherein said step of comparing at least one of said plurality of fields comprises comparing the last two fields to said NSP list.

5. The method of claim 1 wherein said step of applying a rule set comprises parsing at least one field of said plurality of fields to obtain a plurality of sub-fields, wherein one of said subfields contains said city data.

6. The method of claim 5 wherein said step of parsing at least one field of said plurality of fields is performed using a delimiter selected from the group comprising a dash, and a number between zero and nine inclusive.

7. The method of claim 1 wherein when said city data has a number concatenated thereto, said number is discarded.

8. A computer program product for performing determination of a physical locale from an address comprising a computer usable medium having computer readable code thereon, including program code which:
obtains a DNS name of a node on a network;
parses said DNS name into a plurality of fields;
compares at least one of said plurality of fields to a NSP list to determine the NSP of said node;
applies a rule set associated with said NSP to obtain city data; and
references said city data in a reference table associated with said NSP to obtain the physical locale of said node.

9. The computer program product of claim 8 further comprising program code which selects said NSP from the group consisting of alter.net, att.net, bbnplanet.net, cw.net, digex.net, gbix.net, level3.net, qwest.net, sprintlink.net, verio.net, and wcg.net.

10. The computer program product of claim 8 further comprising program code which parses said DNS name using a period as a delimiter.

11. The computer program product of claim 8 further comprising program code wherein which compares the last two fields of said plurality of fields to said NSP list.

12. The computer program product of claim 8 further comprising program code which parses at least one field of said plurality of fields to obtain a plurality of sub-fields, wherein one of said sub-fields contains said city data.

13. The computer program product of claim 12 further comprising program code wherein said parsing at least one field of said plurality of fields is performed using a delimiter selected from the group comprising a dash, and a number between zero and nine inclusive.

14. The computer program product of claim 8 further comprising program code wherein when said city data has a number concatenated thereto, said number is discarded.
